(19) United States
(12) Patent Application Publication
(10) Pub. No.: US 2015/0058401 A1
(43) Pub. Date: Feb. 26, 2015

(54) NETWORK SYSTEM, DISTRIBUTION SYSTEM, CONTROL METHOD, AND STORAGE MEDIUM

(71) Applicant: CANON KABUSHIKI KAISHA, Tokyo (JP)

(72) Inventor: Hisashi Nakamoto, Yokohama-shi (JP)

(21) Appl. No.: 14/452,676

(22) Filed: Aug. 6, 2014

(30) Foreign Application Priority Data
Aug. 23, 2013 (JP) 2013-173647

(51) Int. Cl. H04L 29/06

(52) U.S. Cl. CPC H04L 67/42
USPC 709/203

(57) ABSTRACT

An image forming device of a network system notifies a distribution system, as a client function in response to a first controller provided in the image forming device, of software information related to the first controller and of software information related to the second controller to thereby acquire software to be applied from the distribution system. The distribution system excludes from the objects to be managed a portion of the software from the software related to the first controller when software information related to the second controller is included in the notification from the image forming device to thereby manage the software of the image forming device.

### BACKGROUND OF THE INVENTION

1. Field of the Invention

The present invention relates to a network system including an image forming device and a distribution system that distributes software to the image forming device.

2. Description of the Related Art

A device that provides a function such as image processing, or the like performs a software update that includes firmware used by a controller mounted on the device in the event of malfunction, or to enhance the image processing function. The update method includes a method in which a distribution server distributes software through the Internet, a method in which an update tool is used through the Internet or a USB, or the like. When using a distribution server, management personnel for the device or service personnel who distribute the software designate the device to be the object of distribution on a Web screen and set the distribution date and time to thereby execute distribution through the Internet. The distribution server may also distribute the software in a remote configuration to several tens of thousands devices, or may update the software periodically on a weekly frequency.

Japanese Patent No. 4882291 discloses a system that omits a switching operation by maintenance personnel when updating the software. A client terminal in this system acquires a setting file of the version of a module to be applied from a distribution system during startup of use of the terminal. The client terminal compares the version designated in the version setting file with the version of the software currently applied to the client terminal. The client terminal automatically acquires the software to be applied from the distribution system when determining that an update is required.

To extend the function(s) provided by the device, assume that a second controller is connected to the device separately from a first controller mounted in advance on the device. The second controller for example is manufactured by a different manufacturer to the first controller mounted on the device. Since the manufacturer is different, it is possible to provide advanced image processing functions that are characteristic to each manufacturing company. For example, when the paper grammage, the paper size, the method of post-processing, or the like are taken into consideration depending on the performance of the controller, it is possible to predict the timing of exchange of consumables or replenishment of paper as well as the printing time. Therefore, efficient print job processing is enabled and it is possible to minimize downtime. Furthermore, a large easily-operated display or the like can be connected to the elevational operation unit of the device.

However, the device functions may be subject to degeneracy as a result of connecting the second controller. Generally, the first controller mounted on the device performs control of the principal functions such as printing, and control of accessories such as a finisher, FAX, or the like. However, when the second controller is connected to the device, a function that overlaps with a function controlled by the second controller, or a function that becomes no longer required by reason of a conflict between the functions that are characteristic of the controllers, is reduced from functions of the first controller.

For example, although a device is provided with a liquid crystal operation unit, due to connection of the second controller, the operation unit is not controlled by the first controller, but controlled by the second controller. Furthermore, due to connection of the second controller, page description language (PDL) conversion, that is originally performed by the first controller is reduced from the first controller, but controlled by the second controller. PDL is termed a page description language and is the language used to describe the output image to the printer and command the printer when printing a document, an image or the like that have been created on a computer. Furthermore, due to connection of the second controller, a box function of the first controller is reduced. The box function is the function that enables storage of fax received data, images read by the device, data that has been output on a personal computer (PC), or the like.

The device configuration as described above does not require software distribution management related to overlapping functions or the function that is not required due to the conflict between the functions that are characteristic of the controller due to connection of the second controller. However, current distribution servers cannot determine which software has become unnecessary.

The software for the device that is managed by the distribution server includes software for the first controller and accessory software. The second controller installs software for the second controller and an operating system (OS) for executing the software for the second controller on a PC, and is used by connection to the device. Therefore, modules of the second controller are not supported by the distribution server.

Matching of the software version between the first controller and the second controller is necessary since the number of modules in the overall device will be increased by connection of the second controller to the device. However, current distribution servers are not configured to manage a combination of versions in relation to the software of all modules in the first controller and the second controller. For example, if only the software for the second controller is partially updated, a malfunction may be caused due to the lack of a configuration to manage a software combination over the entire device.

### SUMMARY OF THE INVENTION

According to the present invention, a network system manages a combination of software in a device that can use a plurality of controllers, and thereby enhances the performance of software distribution processing.

According to an aspect of the present invention, the network system includes an image forming device, and a distribution system configured to manage firmware for the image forming device. The image forming device includes a notifying unit configured to notify the distribution system, as a client function corresponding to a first controller provided in the image forming device, of software information related to the first controller, and of software information related to a second controller when the second controller is connected to the image forming device; a receiving unit configured to receive information related to software for applying to its own apparatus from the distribution system; and an acquiring unit configured to acquire software from the distribution system based on the information related to the software to be applied. The distribution system includes a managing unit configured to manage software information for the image forming device by excluding, from among software related to the first controller, a portion of software from software to be managed when software information related to the second controller is included in the notification from the image forming device; and a transmitting unit configured to transmit information related to the software to be applied to the image forming device based on the software information managed by the managing unit as an object to be managed.

Further features of the present invention will become apparent from the following description of exemplary embodiments (with reference to the attached drawings).

### BRIEF DESCRIPTION OF THE DRAWINGS

FIG. 1 illustrates a network system configuration example according to the present invention.

FIG. 2 illustrates a hardware configuration example of a PC, a monitoring device, a host, a distribution server and a monitoring center host.

FIG. 3 illustrates a hardware configuration of respective devices.

FIG. 4 illustrates a software configuration of a communication portion of the distribution server, and a monitoring center host.

FIG. 5 illustrates a software configuration of a communication portion of respective devices and a monitoring apparatus.

FIG. 6 illustrates a structure of a memory map.

FIG. 7 illustrates a software configuration of respective apparatuses.

FIG. 8 illustrates an example of software no longer requiring management upon connection of the second controller.

FIG. 9 illustrates an example of software for a device that is an object to be managed by the distribution server.

FIG. 10 illustrates an example of a module that is required during version checking.

FIG. 11 illustrates a combination of suitable versions that are recorded in the distribution server.

FIG. 12 illustrates version information for the device.

FIG. 13 illustrates an example of related software.

FIG. 14 is a sequence diagram of a firmware updating process of the present embodiment.

FIG. 15 is a sequence diagram of the firmware updating process of the present embodiment.

FIG. 16 illustrates the processing flow in which the distribution server determines the connection of the second controller.

FIG. 17 illustrates the version notification flow of a client module.

FIG. 18 illustrates the processing flow in which the distribution server determines a software malfunction in the device.

FIG. 19 illustrates the processing flow of the distribution server determines a software malfunction in the device.

FIG. 20 illustrates the processing flow when the device installs software.

FIG. 21 illustrates the processing flow when the device installs software.

### DESCRIPTION OF THE EMBODIMENTS

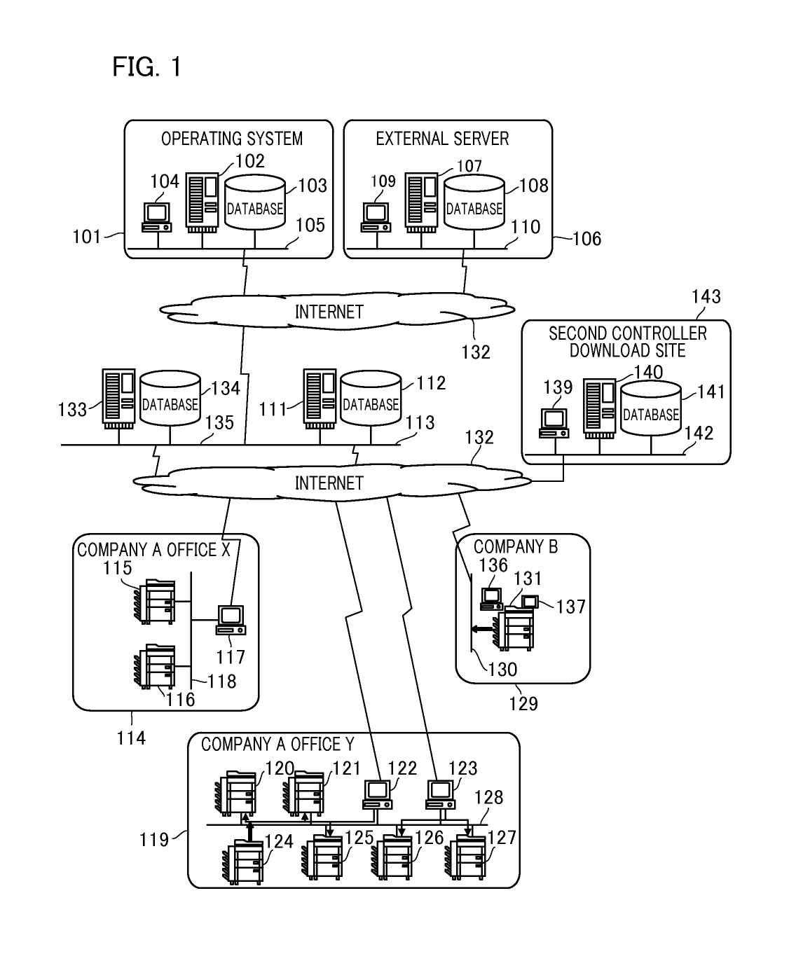

FIG. 1 illustrates an example of the overall configuration of a network system according to the present embodiment. The network system illustrated in FIG. 1 includes an operating system 101, an external server 106, a distribution server 133, a monitoring center host 111, a second controller download site 143, and customer systems 114, 119, 129. The operating system 101 includes a database 103 and a PC 104 that performs control operations such as data recording and correction or the like into the database 103. The PC 104 performs reserved distribution of firmware or browsing of data by accessing a website provided by the distribution server 133 or the monitoring center host 111. The host 102, the database 103, and the PC 104 are connected through a LAN 105.

The network system illustrated in FIG. 1 is illustrated with a configuration formed from a plurality of apparatuses. However, another configuration is possible as long as equivalent functions are realized. For example, the database 103 may also be physically provided in the host 102, or may be provided in another location connected through the Internet as long as access from the host 102 is enabled. That is to say, a configuration from a plurality of apparatuses is possible, or a configuration from a single apparatus is also possible.

The external server 106 includes a host 107, a database 108 and a PC 109. Each of the respective apparatuses is connected through a LAN 110. The external server 106 has a function for providing a service in which the distribution server 133 rapidly distributes firmware.

Next, the monitoring center host 111 will be described. The monitoring center host 111 is a device monitoring system that includes a database 112. The database 112 is a database functions as a history storing unit that stores information for device monitoring, the operational status of a device, or the like. The monitoring center host 111 and the database 112 are connected through a LAN 113, and the LAN 113 is connected to the Internet 132. The database 112 may be physically provided in the monitoring center host 111, or may be provided in another location via the Internet as long as access is enabled from the monitoring center host 111. The monitoring center host 111 has a function for collecting device information and information indicating an operation state that are objects to be monitored from a device 131 or monitoring apparatus 117, 122, 123, accumulating and processing the collected information, to thereby provide an external unit with a warning or the like.

Next, the distribution server 133 will be described. The distribution server 133 functions as a distribution system for distributing firmware to a device. A database 134 is a database functioning as a storing unit configured to accumulate firmware to be applied to the device. The distribution server 133 and the database 134 are connected through a LAN 135 and the LAN 135 is connected to the Internet 132. The database 134 may be physically provided in the distribution server 133, or may be provided in another location via the Internet 132 as long as access is enabled from the distribution server 133. The LAN 113 and the LAN 135 may be the same, and the database 143 and the database 112 may both send and receive data.

FIG. 1 only illustrates a single example of the monitoring center host 111 and the database 112, and the distribution server 133 and the database 134. However, actually, dispersion processing is performed by a plurality of monitoring center hosts 111 and databases for dispersing loads imposed on firmware distribution or information collection from the monitoring apparatuses and the devices may be distributed among a plurality of monitoring center hosts 111 and databases.

Next, a configuration of a customer system will be described. The customer system exhibits a different configuration depending on the customer. FIG. 1 illustrates a customer system 114, 119, and 129. The customer system 114 (office X of company A) includes devices 115, 116 that are connected to a LAN 118 that is connected to the Internet 132. The devices 115 and 116 are monitored by a monitoring apparatus 117, and the monitoring apparatus 117 communicates with the monitoring center host 111 through the Internet 132. On the other hand, the customer system 119 (office Y of company A) includes devices on a LAN 128 that are managed by monitoring devices 122, 123. The monitoring device 122 manages the devices 120, 121, 124 and 125, and the monitoring device 123 manages the devices 126 and 127.

In the customer system 129 (company B), the device 131 itself, that is connected to the LAN 130 connected to the Internet 132, communicates directly with the monitoring center host 111 through the Internet 132. The device 131 includes equivalent functions to the monitoring apparatuses 117, 122, 123, and transmits own operational information to the monitoring center host 111. In the present embodiment, the device 131 is connected to a PC 136 on which the second controller is installed that is different to the first controller that is installed on the device 131. A display 137 is connected to the device 131. The first controller and the second controller may have different manufacturers and thereby enable the device 131 to execute different formatting of data or different image processing functions. The device may be used without the second controller or may be used by connection with the second controller.

A host 140 and a database 141 are connected to the second controller download site 143 through the LAN 142. The second controller download site 143 has a service for distributing software for the second controller.

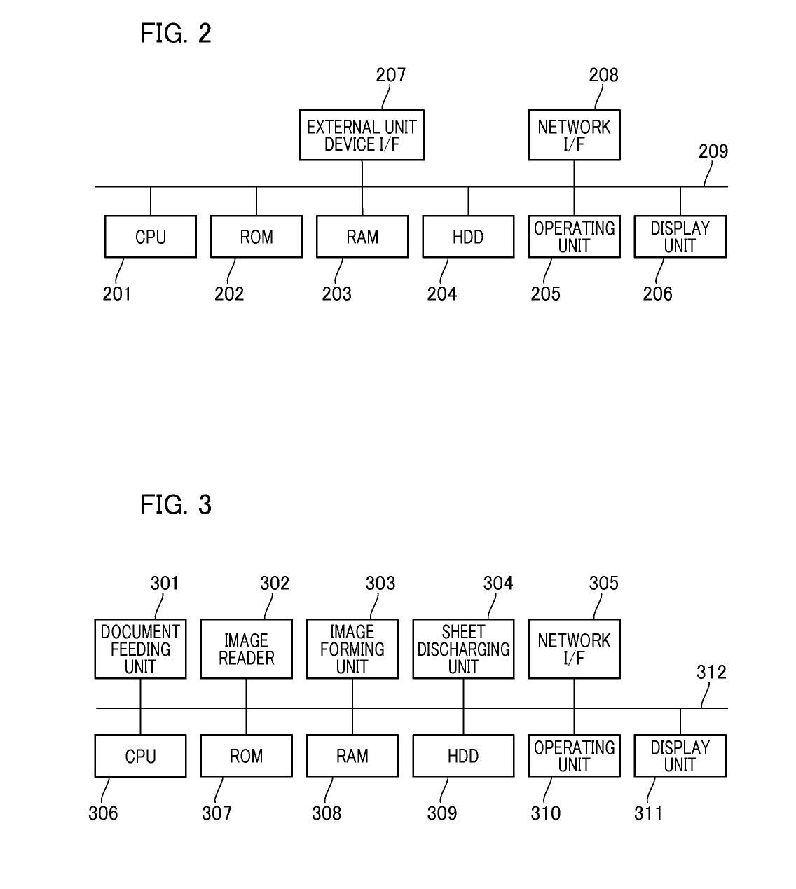

FIG. 2 illustrates a hardware configuration example of the monitoring center host 111. The hardware configuration of the distribution server 133, the host 102, 107, 140, the monitoring apparatus 117, 122, 123, and the PC 104, 109, 136, 139 are the same as that of the monitoring center host 111. As illustrated in FIG. 2, the monitoring center host 111 includes a CPU 201, a ROM 202, a RAM 203, an HDD 204, an operating unit 205, a display unit 206, an external device I/F 207, and a network I/F 208. CPU is an abbreviation for a central processing unit. ROM is an abbreviation for read only memory. RAM is an abbreviation for random access memory. HDD is an abbreviation for hard disk drive.

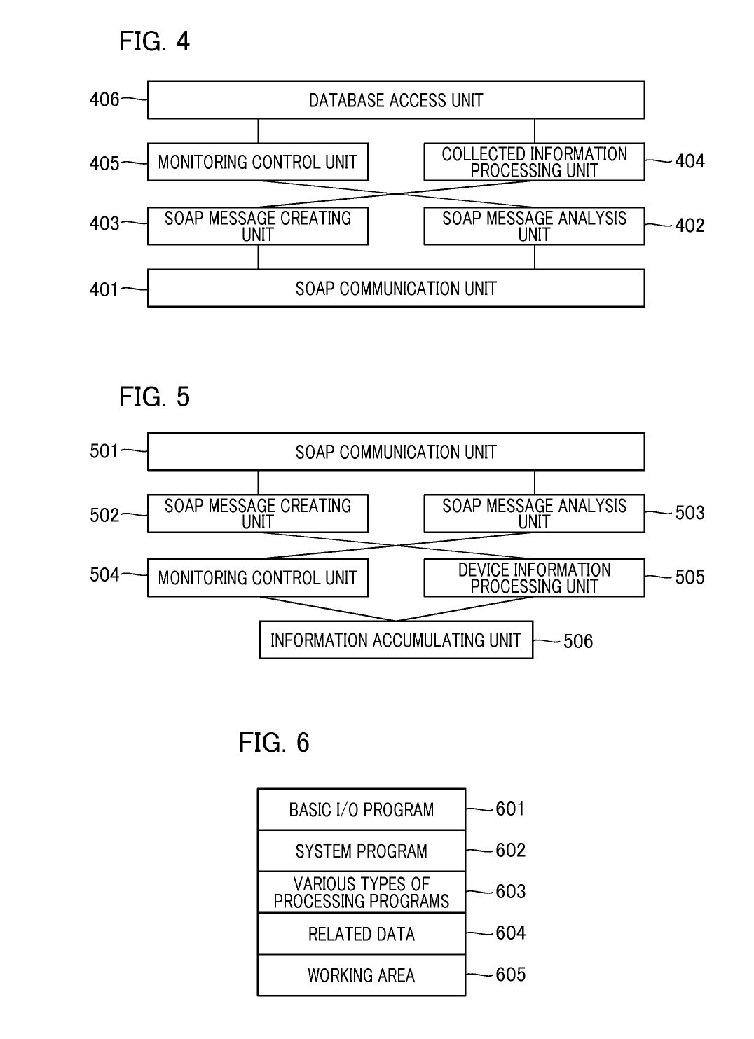

The CPU 201 controls the respective processing units on the monitoring center host 111. The ROM 202 is not rewritable, and stores data or programs related to each processing by the monitoring center host 111. The RAM 203 performs electrical storage of temporary data related to each processing by the monitoring center host 111, and is rewritable. The HDD 204 stores data or programs, and temporary data related to each processing by the monitoring center host 111, information related to a device that is the object of monitoring, and information collected from a device, or the like. For example, the HDD 204 stores operational information or the like. In to the case of the monitoring center host 111 and the distribution server 133, the PC 104 stores programs for the processing illustrated in FIG. 4 as described below on the HDD 204. The programs use the RAM 203 as a temporary storage area, and are executed by calling by the CPU 201.

The operating unit 205 is a keyboard that receives input of commands to the monitoring center host 111. The display unit 206 displays the operating state of the monitoring center host 111, or information output by the respective programs operated on the monitoring center host 111. The network I/F 208 is connected to the Internet 132 and the LAN through the network so as to exchange information with external units. The external unit device I/F 207 is for connecting an external storage device or the like to the monitoring center host 111. These constituent elements are linked by a system bus 209 so as to exchange data.

FIG. 3 illustrates a hardware configuration of respective devices 115, 116, 120, 121, 124, 125, 126, 127 and 131 that function as an image forming device according to the present embodiment. The device specifically includes a multifunction peripheral provided integrally with a printer and facsimile functions, a printer (including an electrophotographic and injector types) that receives data from a PC or the like for printing, a scanner, a facsimile, or the like. The figure illustrates the configuration of a multifunction peripheral as an example of a device.

An image reader 302 reads an original document on a document feeding unit 301. An image forming unit 303 converts data received from the network I/F 305 through the network or a document read by the image reader 302 to a print image, and prints out the same. The sheet discharge unit 304 discharges a sheet that has printed out, and executes processes such as sorting and stapling. The network I/F 305 is connected the LAN and the Internet 132 through the network with, and exchanges information with external units. The CPU 306 controls each of the processing units on the device. The CPU 306 monitors the operational status of the device, and when a specific event such as a malfunction occurs, transmits status information indicating the relevant status to a predetermined destination address. The destination address for example includes the monitoring center host 111, the monitoring apparatus, or the like.

The non-rewritable ROM 307 stores data or a program related to each processing by the device. The RAM 308 performs electrical storage of temporary data related to each processing by the device, and is rewritable. The HDD 309 stores data or programs, and temporary data related to each processing by the device, and user data that is sent to the device, or the like. Each device stores programs for performing the processing in FIG. 5 described below on the HDD 309. These programs use the RAM 308 as a temporary storage area and are executed by calling by the CPU 306.

An operating unit 310 receives input of commands to the device. A display unit 311 displays the operating status of the device, or information related to an operation in relation to the operating unit 310. These constituent elements are linked by a system bus 312 for exchanging data. The device 131 that includes the function for transmitting information for monitoring stores data or a program related to monitoring data transmitting processing in the HDD 309 or the ROM 307.

FIG. 4 illustrates a software configuration of a communication portion of the distribution server 133 and the monitoring center host 111. A SOAP communication unit 401 passes SOAP data received from the monitoring apparatus 117, 122, 123 or the device 131 through the network I/F 208 to a SOAP message analysis unit 402. Furthermore, SOAP data created by the SOAP message creating unit 403 is sent to the monitoring apparatus 117, 122, 123, or the device 131 through the network I/F 208.

A collected information processing unit 404 stores without modification, or processes, information that is received from the monitoring apparatus 117, 122, 123, or the device 131, through the data base access unit 406 and into the database 112 or the database 134. In the case of the monitoring center host 111, a monitoring control unit 405 performs control such as scheduling management or the like for the monitoring apparatus 117, 122, 123, or the device 131. In the case of the distribution server 133, the monitoring control unit 405 performs control such as polling processing or the like for the monitoring apparatus 117, 122, 123, or the device 131.

FIG. 5 illustrates a software configuration of a communication portion of the monitoring apparatus 117, 122, 123, or the device 131. A SOAP communication unit 501 passes SOAP data received from the monitoring center host 111 or the distribution server 133 through the network I/F 208 to the SOAP message analysis unit 503. Furthermore, the SOAP communication unit 501 sends SOAP data created by the SOAP message creating unit 502 to the monitoring center host 111 or the distribution server 133 through the network I/F 208.

A monitor control unit 504 updates device information for objects to be monitored that are retained in an information accumulating unit 506, or acquires information for the device 115, 116. A device information processing unit 505 accumulates operational information for the device in the information accumulating unit 506. The data that is accumulated in the information accumulating unit 506 is passed to the SOAP message creating unit 502 without modification through the device information processing unit 505, and then sent to the monitoring center host 111.

FIG. 6 illustrates a structure of a memory map when a program is loaded onto the monitoring center host 111, the distribution server 133, the monitoring devices 117, 122, 123 or the respective devices. When a processing program according to the present invention is executed, the monitoring center host 111 and the monitoring devices 117, 122, 123 load a program onto the RAM 203 and the respective devices load a program onto the RAM 308.

The memory map is configured by a basic I/O program 601, a system program 602, various types of processing programs 603 including the processing program for the present embodiment, an area 604 for storage of related data, and a working area 605 for the programs. The basic I/O program 601 performs input and output on each apparatus. The system program 602 provides an operational environment for the various processing programs.

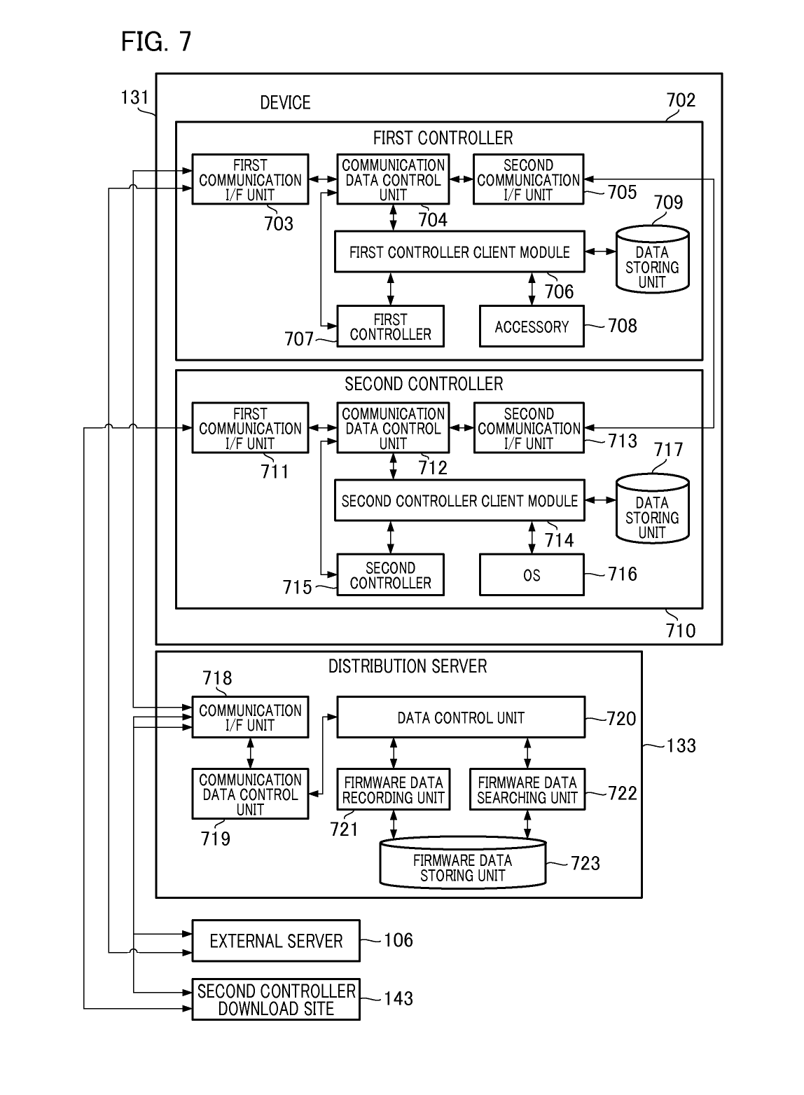

FIG. 7 illustrates a block diagram of respective software configured to realize a network system according to the present invention. The device 131 illustrated in FIG. 7 indicates a state in which the device 131 includes a first controller 702 in the device, and a second controller 710 installed on the PC is connected to the device 131. The first controller 702 includes a first communication I/F unit 703, a communication data control unit 704, a second communication I/F unit 705, a first controller client module 706, a first controller 707, an accessory 708, and a data storing unit 709. The first communication I/F unit 703 controls communication of the first controller 702 with the distribution server 133, and with the external unit server 106. The communication data control unit 704 controls communication data received from the first communication I/F unit 703 and the second communication I/F unit 705.

The second communication I/F unit 705 controls communication with the first controller 702 and the second controller 710. The first controller client module 706 executes various processes as a first client function corresponding to the first controller that is provided in the device. For example, the first controller client module 706 plays the role of receiving software from the external unit server 106 based on the URL information received from the distribution server, and installing the software in the first controller 707 or the accessory 708. The data storing unit 709 is used as a storage area or temporary storage area for software in the first controller.

The second controller 710 includes a first communication I/F unit 711, a communication data control unit 712, a second communication I/F unit 713, a second controller client module 714, a second controller 715, an OS 716, and a data storing unit 717. The first communication I/F unit 711 controls communication of the second controller 710 and the second controller download site 143. The communication data control unit 712 controls communication data received from the first communication I/F unit 711 and the second communication I/F unit 713.

The second communication I/F unit 713 controls communication of the first controller 702 with the second controller 710. The second controller client module 714 executes various processes as a second client function corresponding to the second controller. For example, the second controller client module 714 plays the role of receiving software from the second controller download site 143 based on the URL information received from the first controller client module. The second controller client module 714 has the role of installing the received software in the second controller 715 or the OS 716. The data storing unit 717 is used as a storage area or temporary storage area for software in the second controller.

The distribution server 133 includes a communication I/F unit 718, a communication data control unit 719, a data control unit 720, a firmware data recording unit 721, a firmware data searching unit 722, and a firmware data storing unit 723. The communication I/F unit 718 controls communication between the first controller 702 of the device 131 and the distribution server 133. The communication data control unit 719 controls the communication data received from the communication I/F unit 718. The data control unit 720 performs data control in the distribution server 133.

The firmware data recording unit 721 records information regarding firmware in the firmware data storing unit 723. The firmware data searching unit 722 searches for firmware from the firmware data storing unit 723. The firmware data storing unit 723 stores firmware data for distribution in the distribution server. The firmware data storing unit 723 stores firmware for the first controller 70 and the accessory 708 as an object to be distributed.

As described above, the external unit server 106 has the service in which the distribution server 133 rapidly distributes firmware, and the firmware is periodically transferred by the distribution server 133. The second controller download site 143 stores firmware for the second controller 715 and the OS 716 as an object to be distributed.

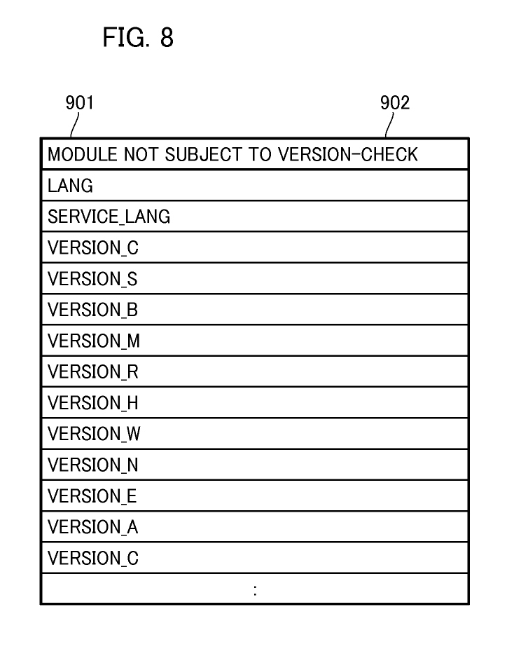

FIG. 8 illustrates an example of a non-applicable software management table 901 stored by the distribution server 133 in the database 134. The non-applicable software management table 901 records a module that is not subject to version-check and that is not required for management when the second controller is connected. The module not subject to version-check 902 indicates a type of software that is not required for management when the second controller is connected. The distribution server 133 refers to the non-applicable software management table 901 when checking a version, and confirms the module not subject to version-check 902. In this manner, a portion of software, among software for the first controller, such as software related to an overlapping function with the second controller or related to a function that is not required due to a function conflict resulting from the characteristics of the controllers can be excluded from the objects to be managed.

As stated above, a device function may be reduced due to connection of the second controller to the device. Since the first controller is mounted onto the device, the first controller controls principal functions such as copying, printing or the like, and accessory functions such as finishing, FAX or the like. However, when the second controller is connected to the device, functions of the first controller that are interchangeable with the functions of the second controller are reduced.

Version management of reduced functions results in an adverse effect on the performance of software distribution in addition to unnecessary processing by the distribution server 133. Therefore, in the present embodiment, when the second controller is connected to the device, the software subject to be reduced such as that software stored in the non-applicable software management table 901 does not require management. Furthermore, even when the second controller is connected, when the second controller functions are not used, the software stored in the non-applicable software management table 901 is managed in order to ensure normal device handling. When the second controller functions are not used, the second controller is determined as not being connected in because information related to software used in the second controller is not notified from the device to the distribution server 133.

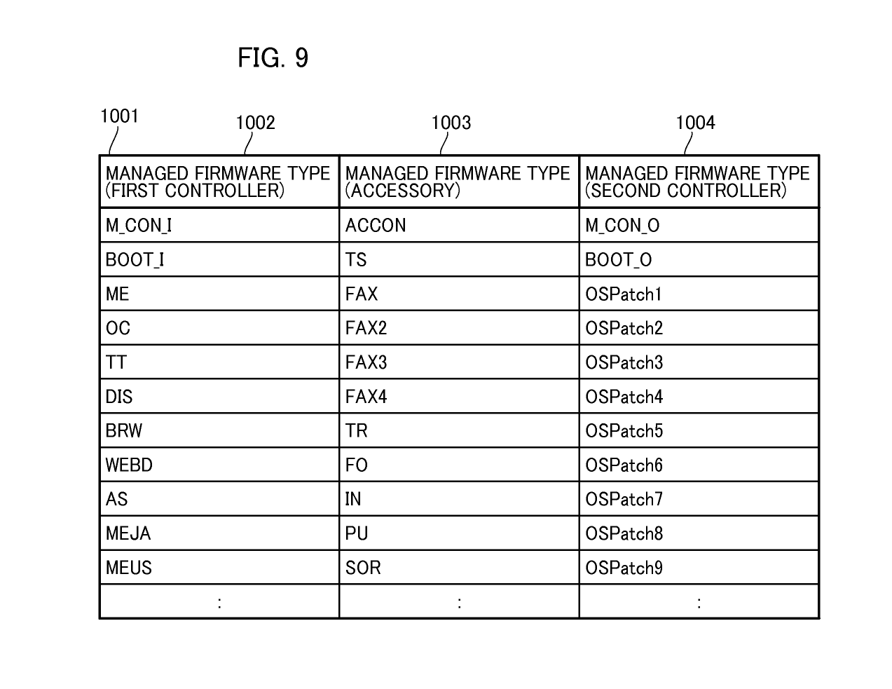

FIG. 9 illustrates an example of an applicable software management table 1001 stored in the database 134 by the distribution server 133. The applicable software management table 1001 stores a list of software to be managed by the distribution server 133. A managed firmware type 1002 stores software to be managed for the first controller 707. The managed firmware type 1003 stores software to be managed for the accessory 708. The managed firmware type 1004 stores software to be managed for the second controller 715 and the OS 716. All the software stored in the table 1001 is described using a unique identifier for each module being a firmware type.

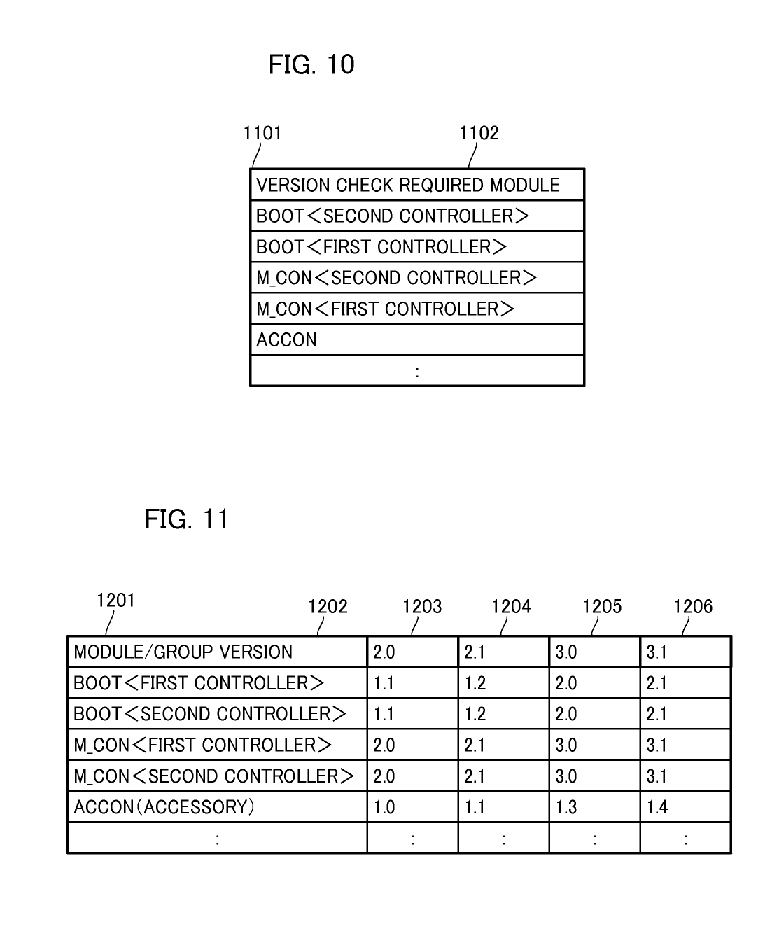

FIG. 10 illustrates an example of a version check required software management table 1101 stored in the database 134 by the distribution server 133. A version check required module 1102 stores a list of modules requiring checking by the distribution server 133 during version checking. A version check required module is a module that affects the function of both the first controller 707 and the second controller 715. Since deviation of the version of the version check required module from a suitable version results in an increase of possibility of a malfunction in the device, it is necessary to check the module that affects the function.

FIG. 11 illustrates a version management table 1201 that is stored in the database 134 by the distribution server 133. The version management table 1201 stores the combinations of suitable versions. The table 1201 indicates modules in the rows and the group version in the columns such as module/group version 1202. The group version 1203 to 1206 stores the version of the group. The column for each group version stores the version of the corresponding module. As illustrated in FIG. 11, group versions 1203, 1204, 1205, 1206 respectively store the versions 2.0, 2.1, 3.0, 3.1.

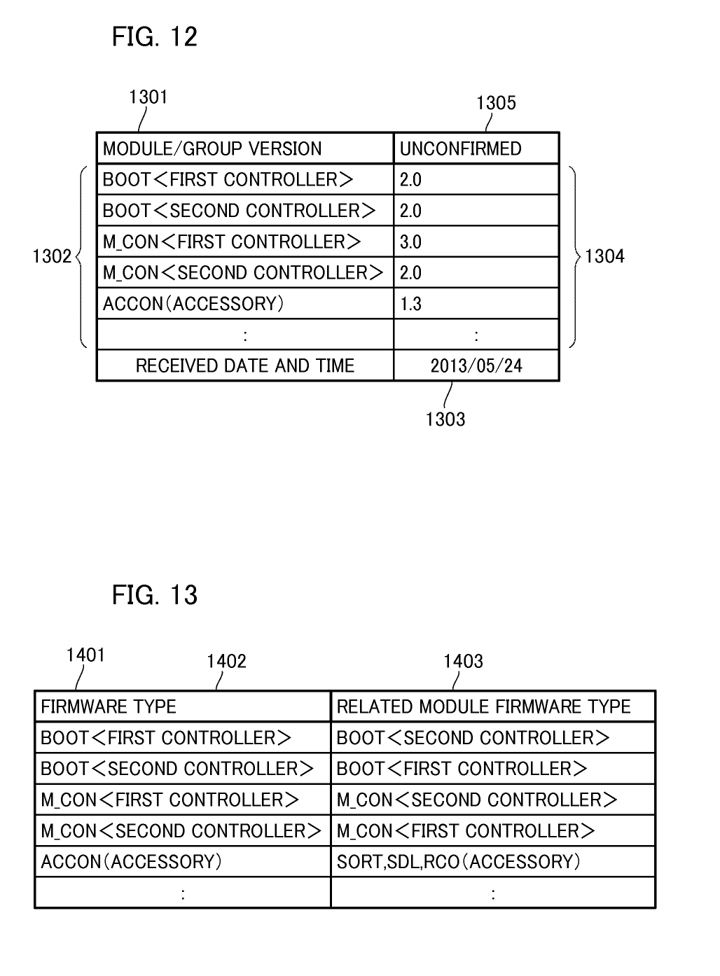

FIG. 12 illustrates an example of a version information table 1301 stored in the database 134 by the distribution server 133. The version information table 1301 stores the version information for a device. The table 1301 stores modules 1302 in the rows and the group versions 1305 in the columns. The table 1301 also stores the date and time at which a notification of the version is received from the device as shown by a received date and time 1303. The version information 1304 stores the combination of versions of software notified from the device 131. The group version 1305 indicates a group version in which versions of all the modules are integrated, and represented as a single version. In the event that a version 1304 that does not correspond to the table of the version management table 1201 is included, the group version 1305 stores the group version as “unconfirmed”. In the present embodiment, assume that the module that is used as a reference when the distribution server 133 compares the versions of the modules is M-CON (first controller) that is the main module of the first controller.

FIG. 13 illustrates an example of a related software table 1401 stored in the database 134 by the distribution server 133. The module name is stored in a firmware type 1402. A related module firmware type 1403 stores the firmware type related to the firmware type 1402. The related module is a module that depends on the version of the module of the firmware type 1402. When the version of the firmware type 1402 is changed, it is necessary also to change the version of the firmware type 1403.

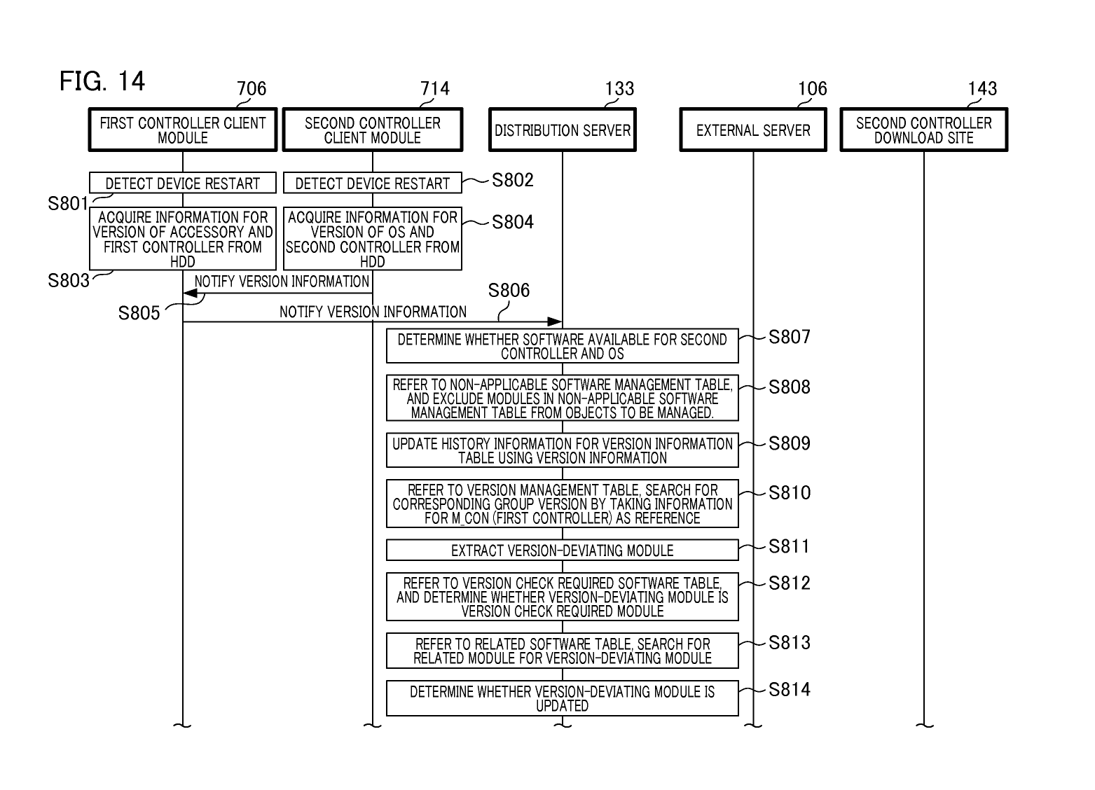

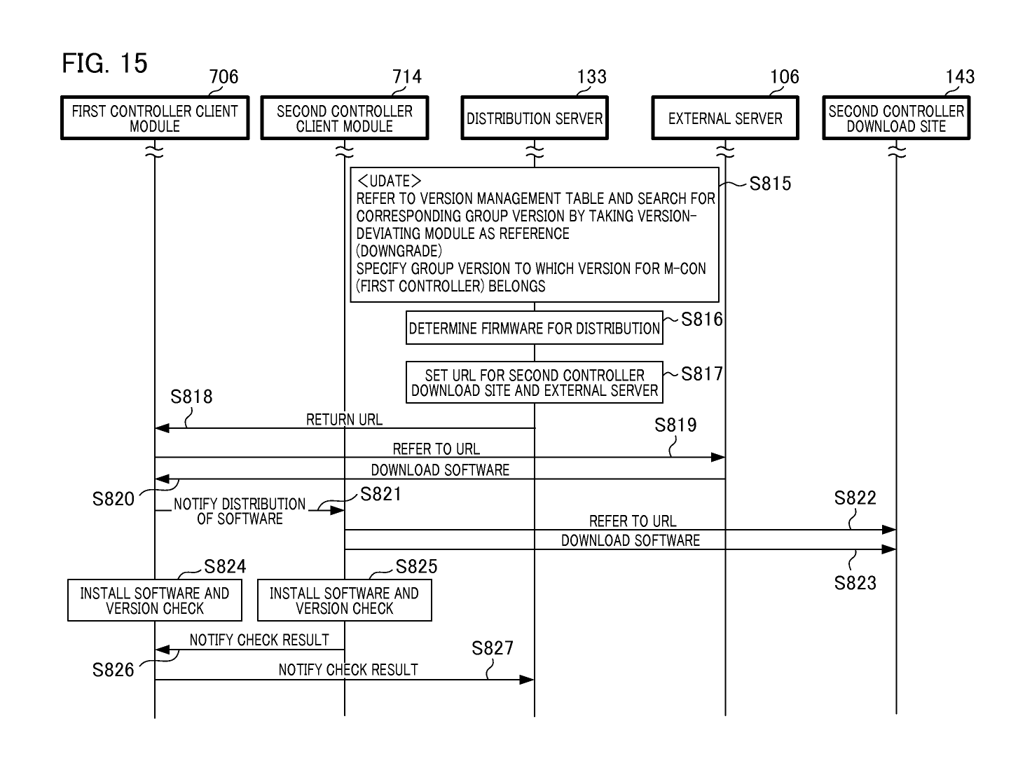

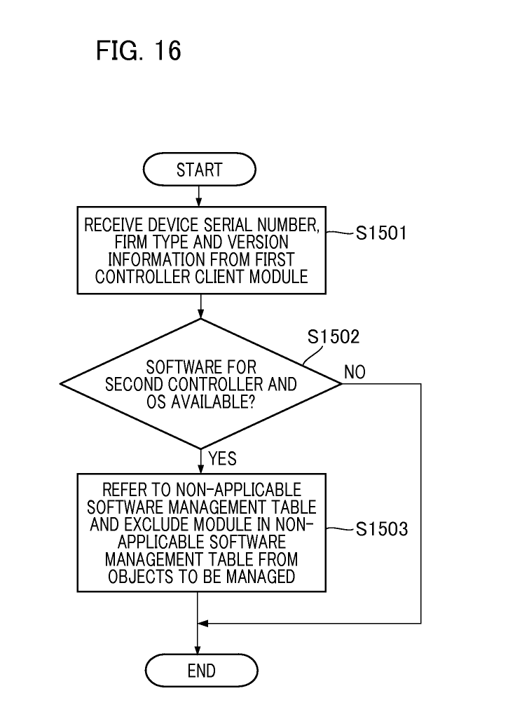

FIG. 14 is a sequence diagram of software distribution processing according to the present embodiment. In this sequence, it is assumed that the second controller is connected, and that there is software for distribution to both the first controller and the second controller. The details of the processing will be described using the flowcharts in FIG. 16 to FIG. 20, and the general features of the software distribution processing will be described with the sequence.

In S801 and S802, the first controller client module 706 (referred to below as the first module 706) and the second controller client module 714 (referred to below as the second module 714) detect restarting of the device. In S803, the first module 706 refers to the HDD 309 to acquire software version information in relation to the modules included in the first controller 707 and the accessory 708.

In S804, the second module 714 refers to the HDD 204 to acquire software version information in relation to the modules included in the second controller 715 and the OS 716.

In S805, the second module 714 notifies version information acquired in S804 to the first module 716. In S806, the first module 706 notifies version information for all modules in the device to the distribution server 133.

In S807, the distribution server 133 determines whether the version information notified from the first controller client module 706 includes version information for the second controller 715 and the OS 716. In S808, the distribution server 133 refers to the non-applicable software management table 901 and excludes a module in the non-applicable software management table 901 from an object to be managed for the device. In S809, the distribution server 133 records the combination of the version information received in S806 as version information 1304 in the version information table 1301 and updates history information.

In S810, the distribution server 133 refers to the version management table 1201 illustrated in FIG. 11 by taking information for M_CON (first controller) for version information 1304 that is recorded as shown in FIG. 12 as a reference, and searches for the corresponding group version. The distribution server 133 determines the suitable combination if all recorded versions match version that is recorded in the version management table 1201, and in the event of a mismatch, determines that the combination is not suitable. The version (M_CON (first controller) that is recorded in the version information 1304 is the version 3.0. The distribution server 133 extracts the column for the group version 1205. The processing result in S810 is shown below.

### “Comparison Result of Suitable Information 1205 and Version Information 1304”

[Comparison Result]: no corresponding group version
[Group Version same as M_CON (first controller)]: 1205
[Module with deviating Version]: M-CON (second controller)
[Difference]: “2.0” in version information 1304, “3.0” in suitable version information 1205
[Event]: Actual downgrade to “2.0” although should be “3.0”

In S811, the distribution server 133 extracts the module that has a deviating version (M-CON (second controller)) from the result of the processing in S810. In S812, the distribution server 133 refers to the version check required software management table 1101 illustrated in FIG. 10 and determines whether the module with the deviating version is a version check required module. In the processing in S812, the distribution server 133 determines that M-CON (second controller) is a version check required module.

In order to ensure consistency throughout the entire system, simultaneous updating of a related module that is affected by the mismatch module is required. Making reference to the related software table 1401 illustrated in FIG. 13, the distribution server 133 searches for a module related to the module (M-CON (second controller)) exhibiting a deviating version. In S814, the result of the processing in S810 are used in S814 to determine whether the module exhibiting the deviating version has been upgraded or downgraded. In the present embodiment, the distribution server 133 determines that the version of M-CON (second controller) has been downgraded from 3.0 to 2.0.

In S815, in the case of the upgrade result, the distribution server 133 refers to the version management table 1201 illustrated in FIG. 11, and searches for a corresponding group version by taking the version-deviating module as a reference. In the case of the upgrade result, since only the version-deviating module is a module having the latest version, the related modules must also be upgraded to the latest version. In the case of the downgrade result, since only the version-deviating module is a module having an old version, only the version-deviating module needs to be recovered to a suitable version. Therefore, the distribution server 133 extracts the version 3.0 for M-CON (second controller) from the specified group version.

In S816, the distribution server 133 determines software to be distributed. In the present embodiment, the version 3.0 for M-CON (second controller) is designated as the software to be distributed. In S817, when the software to be distributed is for use with the first controller, the distribution server 133 sets the URL for the external server 106. On the other hand, when the software to be distributed is for use with the second controller, the distribution server 133 sets the URL for the second controller download site 143. In S818, the distribution server 133 passes the URL for the software to be distributed to the first module 706 as a reply.

In S819, the first module 706 accesses the URL for the software to be distributed received from the distribution server 133. In S820, the first module 706 downloads the software from the external server 106 to the HDD 309 in the device. In S821, the first module 706 transmits the URL to the second module 714, and notifies the installation request. In S822, the second module 714 accesses the URL received from the first module 706. In S823, the second module 714 refers to the URL, and downloads the software to be distributed from the second controller download site 143 to the HDD 204.

In S824, the first module 706 executes a version check for the software, and confirms whether installation has been performed correctly. In S825, the second module 714 executes a version check for the software, and confirms whether installation has been performed correctly. In S826, the second module 714 transmits the check result to the first module 706. In S827, the first module 706 transmits the check result to the distribution server 133. The distribution server 133 receives the check result from the first module, and updates the version information table 1301. Although a configuration is described in which the version information table 1301 is updated upon receipt of the check result from the first module 706, a configuration is not limited thereto. The distribution server 133 may update the version information table 1301 at the point when the software to be distributed is determined in S816. Furthermore, the distribution server 133 may refer to the version management table 1201 illustrated in FIG. 11 after updating the version information table 1301, and again determine whether or not the group version shown in the updated results is a suitable combination. With the above processing, the network system of the present invention can manage a software combination in a device that uses a plurality of controllers and thereby enhance the performance of the software distribution processing. The distribution server compares the respective version information and creates information related to the software to be applied according to the matched version combination for software, and therefore matching of the versions of the respective software is ensured.

FIG. 16 illustrates the processing flow for the distribution server 133 to determine whether the second controller is connected to the device. In this processing flow, the data control unit 720 illustrated in FIG. 7 performs the determination by use of information received from the device 131 through the communication I/F unit 718. In S1501, the distribution server 133 receives the device serial number, the firmware type, and the version information from the first controller client module 706. The device serial number is the unique number for an individual device. As discussed above, the firmware type is the unique identifier to each module as shown in the table for the applicable software management table 1001. The version information is the version information for each module.

In S1502, the distribution server 133 determines whether software information that includes version information for the OS 716 and the second controller 715 is present in the device version information. The determination method determines the presence of software for the OS 716 and the second controller 715 when the firmware type 1004 to be managed for the OS and the second controller is notified to the distribution server 133. When the second controller is present, the process proceeds to S1503, and when not present, the processing is terminated.

In order to facilitate comprehension, Tables 1001, 1101, 1201, 1301, 1401 in the present specification stores the same firmware type for the first controller and the second controller such as M_CON or BOOT. However, actually, the firmware type is defined so that the firmware type is unique.

In S1502, when the second controller is determined to be connected, the distribution server 133 in S1503 refers to the non-applicable software management table 901 as illustrated in FIG. 8. The module for the first controller that is not necessary when the second controller is connected is excluded from the management objects for the device.

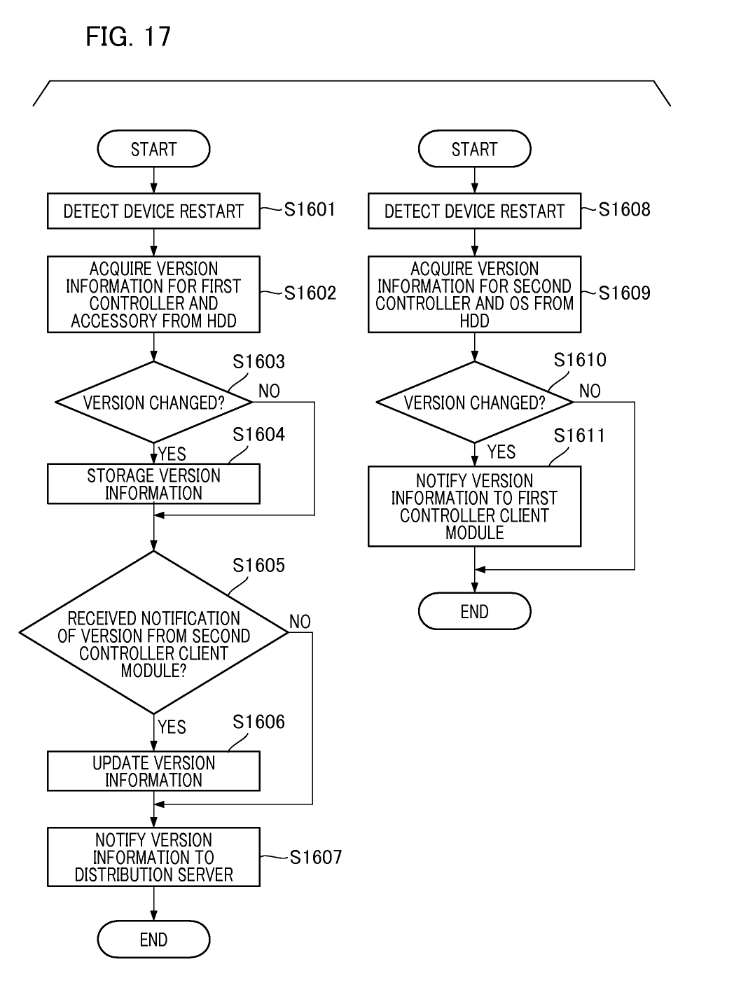

FIG. 17 illustrates the version notification flow of the client module upon restart. In S1601, the first controller client module 706 detects restart up of the device. In S1602, the first module 706 refers to the HDD 309 so as to acquire software version information in relation to the module that is included in the first controller 707 and the accessory 708.

In S1603, when the first module 706 detects a version change, the processing proceeds to S1604. When no detection occurs, the processing proceeds to S1605. In S1604, the first controller client module 706 stores the version information acquired in S1602 in the HDD 309 of the device. In S1605, the first module 706 determines whether a version notification has been received from the second controller client module 714. When the notification is received, the processing proceeds to S1606, and when the notification is not received, the processing proceeds to S1607.

In S1606, the first module 706 updates the version information based on the information notified from the second module 714 in S1605. In S1607, the first module 706 notifies the version information to the distribution server 133.

In S1608, the second module 714 detects restarting of the device at the same timing as the first module 706. In S1609, the second module 714 refers to the HDD 204 so as to acquire software version information for the module included in the second controller 715 and the OS 716. In S1610, when a version change of the software is detected, the processing proceeds to S1611, and when it is not detected, the processing is terminated. In S1611, the second controller client module 714 notifies version information to the first controller client module 706.

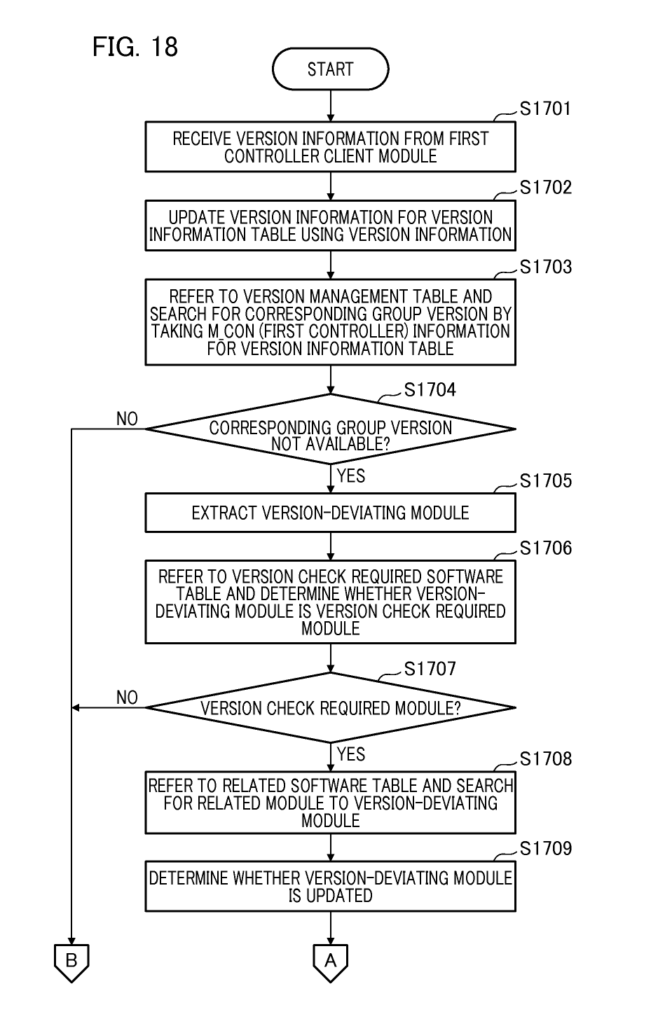

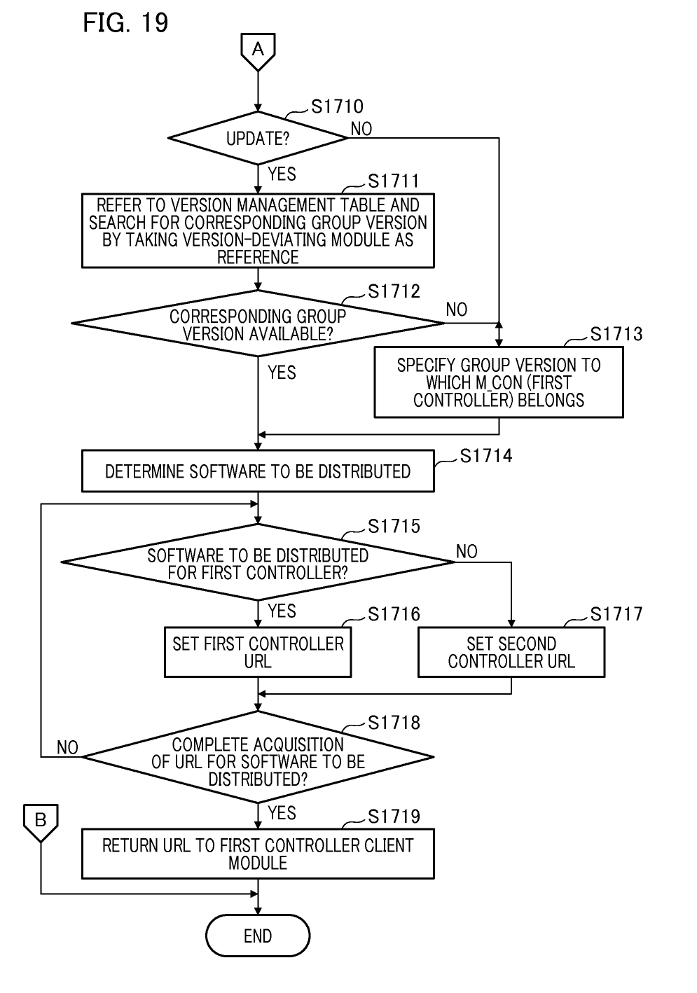

FIG. 18 and FIG. 19 illustrate the processing flow of the data control unit 720 of the distribution server 133 to determine a software version mismatch in the device. In S1701, the distribution server 133 receives version information from the first controller client module 706. In S1702, the distribution server 133 records the version information received in S1701 as a group version 1304 in the version information table 1301 illustrated in FIG. 12. In S1703, the distribution server 133 refers to the version management table 1201 by taking the information for M_CON (first controller) of the group version 1304 as a reference, and searches for a corresponding group version. In this context, the version information 1304 corresponds to the group version 1205.

Next, the distribution server 133 compares the group version 1304 with the suitable group version 1205. As a result, only the version for M-CON (second controller) is different. The comparison result is shown below.

### “Comparison Result of Suitable Information 1205 and Version Information 1304”

[Comparison Result]: no corresponding group version
[Group Version same as M_CON (first controller)]: 1205
[Module with deviating Version]: M-CON (second controller)
[Difference]: “2.0” in version information 1304, “3.0” in suitable version information 1205
[Event]: Actual downgrade to “2.0” although should be “3.0”

In S1704, the distribution server 133 uses the processing result in S1703 to determine whether the group version corresponding to the version information 1304 is present in the version management table 1201. When the group version is not present, the processing proceeds to S1705, and when the corresponding group version is present, the processing is terminated. Since the result of the processing in S1703 is “comparison result”: corresponding group version not present, the processing proceeds to S1705. In S1705, the distribution server 133 uses the result in S1703 to extract the module having the deviating version. Since the result of S1703 is [Module with deviating Version]: M-CON (second controller), the distribution server 133 extracts M-CON (second controller).

In S1706, the distribution server 133 refers to the version check required software management table 1101 and determines whether M-CON (second controller) that is the module with the deviating version is a version check required module. M-CON (second controller) is present in the version check required software management table 1101, and therefore the distribution server 133 determines that M-CON (second controller) is a version check required module.

In S1707, the distribution server 133 proceeds to S1708 when the result of S1706 represents a version check required module. Otherwise, it is determined that a malfunction is not occurred in the device, and the processing is terminated. In S1708, the distribution server 133 refers to the related software table 1401 and searches for a related module to the module having a deviating version. Since the result of S1703 is that [Module with deviating Version]: M-CON (second controller), the distribution server 133 refers to the related software table 1401, and determines that the M-CON (first controller) is the related module.

In S1710 in FIG. 19, in the case of upgrade, the processing proceeds to S1711, and in the case of downgrade, the processing proceeds to S1713. In S1711, the distribution server 133 refers to the version management table 1201 and searches for the corresponding group version by taking the module with the deviating version as a reference. In the case of upgrade, since only the module with the deviating version is a module having the latest version, the related modules must also be upgraded using the latest version. In S1712, the distribution server 133 searches the version management table 1201 by taking the module with the deviating version as a reference, and when there is a corresponding group version, the processing proceeds to S1714, otherwise, the processing proceeds to S1713.

In S1713, the distribution server 133 specifies the group version to which the version for M-CON (first controller) searched in S1703 belongs. In the case of downgrade, since only the version-deviating module is in an old state, only this module needs to be recovered to a suitable version. Therefore, the distribution server 133 extracts the version for M-CON (second controller) from the specified group version. Even when a module having a newer version than that of M-CON (first controller) is included, if that module is not recorded in the version management table 1201, a combination in which M_CON (first controller) is taken as a reference is applied. In the present embodiment, since M_CON (first controller) belongs to the group version 1205, the group version 1205 is specified as a suitable combination.

In S1714, the distribution server 133 determines the firmware to be distributed. Based on the result of S1703 to S1713, the firmware to be distributed is as follows.

### [Firmware to be Distributed]

| | |
|---|---|
| Group Version | 1205 |
| M-CON (Second Controller) | 3.0 |
| M-CON (First Controller) | 3.0 |

In S1715, the distribution server 133 sets the URL for the external server 106 as the URL for the first controller in S1716 when the software to be distributed is for use with the first controller. On the other hand, when the software to be distributed is for use with the second controller, in S1717, the URL for the second controller download site 143 is set as the URL for the second controller.

In S1718, when acquisition of the URLs for all the software to be distributed is completed, the processing proceeds to S1719, and when acquisition is not completed, the processing returns to S1715. In S1719, the distribution server 133 passes the URLs of the software to be distributed to the first controller client module 706.

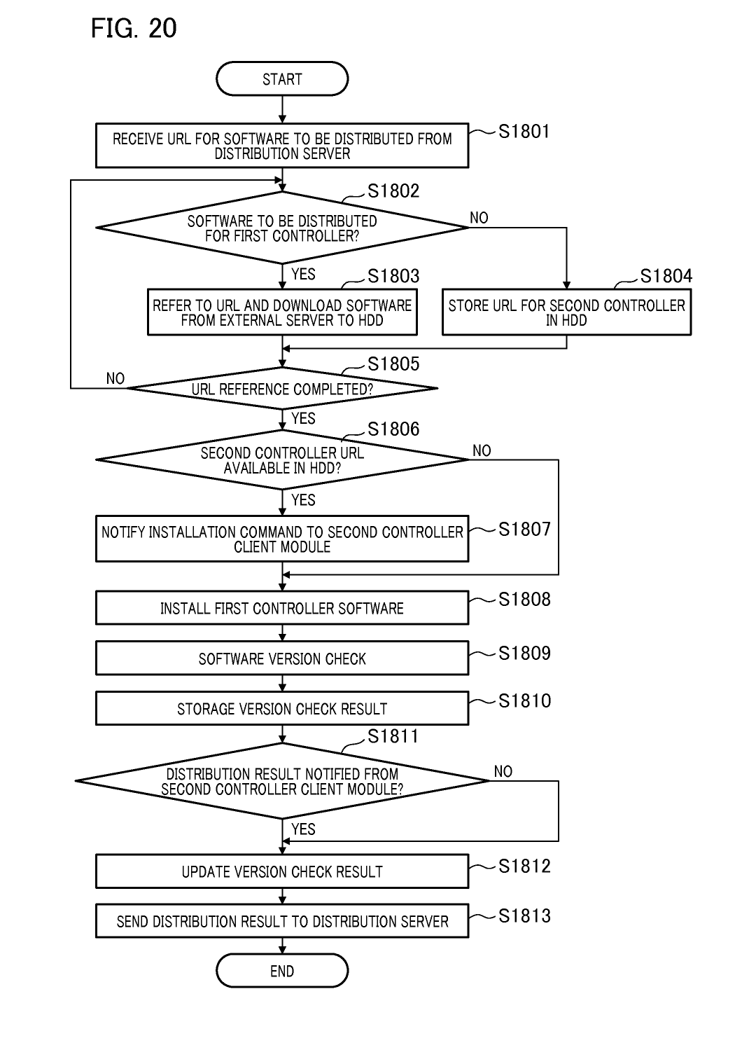

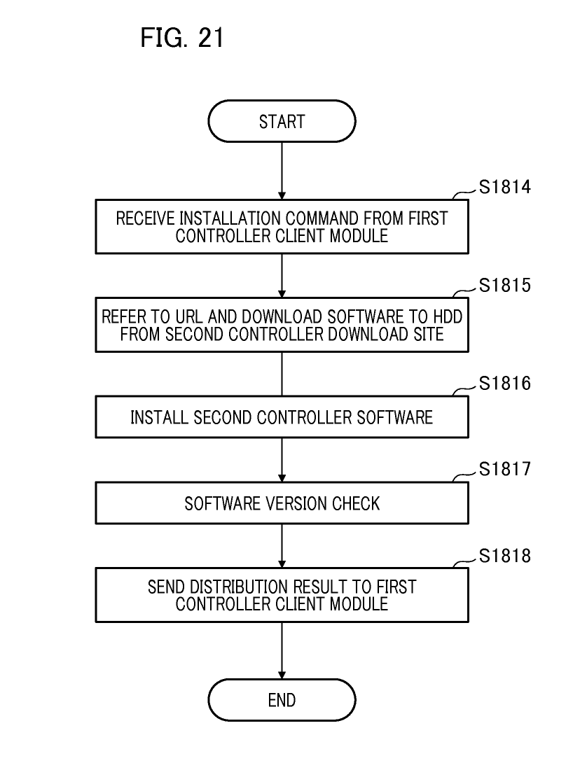

FIG. 20 and FIG. 21 illustrate the software installation flow on the device side. FIG. 20 illustrates the software installation flow for the first controller client module 706. In S1801, the first controller client module 706 receives the URL(s) for the software to be distributed from the distribution server 133. In S1802, the first module 706 determines whether the software to be distributed is for use with the first controller or the second controller. When for use with the first controller, the processing proceeds to S1803, and when for use with the second controller, the processing proceeds to S1804.

In S1803, the first module 706 downloads the software from the external server to the HDD 309 in the device. In S1804, the first module 706 stores the URL for the second controller in the HDD 309. In S1805, if the first module 706 has completed reference of all URLs, the processing proceeds to S1806, otherwise, the processing returns to S1802. In S1806, the first module 706 confirms whether the second controller URL is present in the HDD 309. When present, the processing proceeds to S1807 and when not present, the processing proceeds to S1808.

In S1807, the first module 706 notifies an installation request to the second controller client module 714. In S1818, the first module 706 installs the first controller software.

In S1809, the first module 706 performs software version checking, and confirms whether installation has been performed correctly. The first controller client module 706 confirms the module version after updating, and when the module version is updated to the version designated by the URL, determines that installation has been performed correctly. In the event that even one module is not of a version designated by the URL, it is determined that installation has failed. For example, when the firmware to be distributed is determined in S1714:

### [Firmware to be Distributed]

| Group Version | 1205 |
|---|---|
| M-CON (Second Controller) | 3.0 |
| M-CON (First Controller) | 3.0 |

When the first module 706 has updated M-CON (first controller) to “3.0”, installation is successful, and when another version has resulted, installation has failed.

In S1810, the first module 706 stores the version check result in the HDD 309. In S1811, the first module confirms whether the distribution result has been notified from the second module 714. When notification has occurred, the processing proceeds to S1812, and notification has not occurred, the processing proceeds to S1813. In S1812, the first module 706 updates the version check result, and adds the version check result for the second controller. In S1813, the first module 706 transmits the distribution result to the distribution server 133.

FIG. 21 illustrates the software installation flow for the second module 714. In S1814, the second module 714 receives the installation command from the first module 706. In S1815, the second module 714 refers to the URL, and downloads the software from the second controller download site 143 to the HDD 204. In S1816, the second module 714 installs the second controller software.

In S1817, the second module 714 checks the software version and confirms whether the installation has been performed correctly. The second module 714 confirms the module version after updating, and when updating has occurred in the version designated by the URL, determines that installation has been performed correctly. On the other hand, in the event that even one module is not of a version designated by the URL, it is determined that installation has failed. For example, when the firmware to be distributed is determined in S1714:

### [Firmware to be Distributed]

| Group Version | 1205 |
|---|---|
| M-CON (Second Controller) | 3.0 |
| M-CON (First Controller) | 3.0 |

When the second controller second module 714 has updated M-CON (second controller) to “3.0”, installation is successful, and when another version results, installation fails. In S1818, the second module 714 transmits the distribution result to the first module 706.

As described above, the network system of the present invention enables exclusion of unnecessary software from objects to be managed in a device that can be controlled by a plurality of controllers to thereby enhance the performance of software distribution processing. The network system of the present invention can determine software in relation to which management is not required, and therefore has the advantage that updating of other software that depends on the unnecessary software can be freely performed. For example, M_CON that is the execution module of the main controller and the software for LANG that is the UI resource for the main controller exhibit a high level of dependency, and therefore there is the limitation that LANG software for which both versions are not the same cannot be used. However, the present invention enables free updating of M_CON without the above limitation by causing LANG software that cannot be used during connection of the second controller to not require distribution management. Furthermore, combinations of all the software for the first controller and the second controller can be managed, and therefore a mismatch in relation to software in a device can be prevented even when there is a partial update.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-173647, filed Aug. 23, 2013 which is hereby incorporated by reference herein in its entirety.

What is claimed is:

1. A network system comprising an image forming device, and a distribution system that manages software for the image forming device:
wherein the image forming device comprises:
a notifying unit configured to notify the distribution system, as a client function corresponding to a first controller provided in the image forming device, of software information related to the first controller, and of software information related to a second controller when the second controller is connected to the image forming device;
a receiving unit configured to receive information related to software for applying to its own apparatus from the distribution system; and
an acquiring unit configured to acquire software from the distribution system based on the information related to the software to be applied; and
wherein the distribution system comprising:
a managing unit configured to manage software information for the image forming device by excluding, from among software related to the first controller, a portion of software from software to be managed when software information related to the second controller is included in the notification from the image forming device; and
a transmitting unit configured to transmit information related to the software to be applied to the image forming device based on the software information managed by the managing unit as an object to be managed.

2. The network system according to claim 1, wherein the distribution system further includes a creating unit configured to compare version information for software related to the first controller with version information for software related to the second controller among software information managed by the managing unit as the object to be managed, and to create information related to the software to be applied in relation to the image forming device in accordance with a matching combination for the software versions, and wherein the transmitting unit is configured to transmit the created information related to the software to be applied.

3. The network system according to claim 1, wherein the acquiring unit is configured to acquire software related to the first controller from the distribution system through the client function corresponding to the first controller, and acquire software related to the second controller from a different system from the distribution system through a client function corresponding to the second controller.

4. The network system according to claim 1, wherein, upon restart of its own device, the notifying unit notifies the distribution system of version information for software related to the first controller when a version of software related to the first controller is changed, and furthermore of version information for software related to the second controller based on a notification from the client function corresponding to the second controller.

5. The network system according to claim 2, wherein the creating unit compares a combination of versions included in the version information for software related to the first and second controllers with the matching combination of the software versions, and when software without a matching version is extracted, creates the information related to the software to be applied to the image forming device so that the combination of versions included in the version information becomes the matching combination.

6. The network system according to claim 5, wherein the creating unit creates the information related to the software to be applied so that the software of the version included in the matching combination is applied to the image forming device when the version of the software that does not match is an older version than the version included in the matching combination, and
when the version of the software that does not match is newer than the version included in the matching combination, creates the information related to the software to be applied to the image forming device so that a combination is configured from versions of software retrieved from the managed software information by taking the new version as a reference.

7. A distribution system that manages software for an image forming device, comprising:
a managing unit configured to receive software information for the image forming device as a client function corresponding to a first controller provided in the image forming device and software information related to a second controller connected to the image forming device so as to manage software information for the image forming device by excluding, from among software related to the first controller, a portion of software from software to be managed;
a creating unit configured to compare software information related to each controller managed by the managing unit, and to create information for causing the image forming device to access the distribution system through the client function corresponding to the first controller when it is determined that software related to the first controller is distributed in accordance with the matching combination for the software versions, and create information for causing the image forming device to access a system that is different to the distribution system that distributes software related to the second controller through a client function corresponding to the second controller when it is determined that software related to the second controller is distributed; and
a transmitting unit configured to transmit the created information to the image forming device.

8. A control method in a network system comprising an image forming device, and a distribution system configured to manage the software for the image forming device, comprising:
notifying, by the image forming device as a client function corresponding to a first controller provided in the image forming device, the distribution system of software information related to the first controller, and of software information related to a second controller when the second controller is connected to the image forming device;
receiving, by the image forming device, information related to software for applying to its own apparatus from the distribution system;
acquiring, by the image forming device, software from the distribution system based on the information related to the software to be applied;
managing, by the distribution system, software information for the image forming device by excluding, from among software related to the first controller, a portion of software from software to be managed when software information related to the second controller is included in the notification from the image forming device; and
transmitting, by the distribution system, information related to the software to be applied to the image forming device based on the software information managed as an object to be managed.

9. A control method in a distribution system that manages software for an image forming device, comprising:
receiving software information for the image forming device as a client function corresponding to a first controller provided in the image forming device and software information related to a second controller connected to the image forming device so as to manage software information for the image forming device by excluding, from among software related to the first controller, a portion of software from software to be managed;
comparing software information related to each controller managed by the managing unit, and creating information for causing the image forming device to access the distribution system through the client function corresponding to the first controller when it is determined that software related to the first controller is distributed in accordance with the matching combination for the software versions, and creating information for causing the image forming device to access a system that is different to the distribution system that distributes software related to the second controller through a client function corresponding to the second controller when it is determined that software related to the second controller is distributed; and
transmitting the created information to the image forming device.

10. A non-transitory storage medium on which is stored a computer program for making a computer execute a control method in a distribution system that manages software for an image forming device, comprising:
receiving software information for the image forming device as a client function corresponding to a first controller provided in the image forming device and software information related to a second controller connected to the image forming device so as to manage software information for the image forming device by excluding, from among software related to the first controller, a portion of software from software to be managed;
comparing software information related to each controller managed by the managing unit, and creating information for causing the image forming device to access the distribution system through the client function corresponding to the first controller when it is determined that software related to the first controller is distributed in accordance with the matching combination for the software versions, and creating information for causing the image forming device to access a system that is different to the distribution system that distributes software related to the second controller through a client function corresponding to the second controller when it is determined that software related to the second controller is distributed; and
transmitting the created information to the image forming device.
